(19) United States
(12) Patent Application Publication
(10) Pub. No.: US 2010/0003992 A1
(43) Pub. Date: Jan. 7, 2010

(54) Finding Hidden Cells in a Mobile Communication System

(75) Inventors: Aijun Cao, Lulea (SE); Jan Johansson, Norrfjarden (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 12/166,303

(22) Filed: Jul. 1, 2008

(51) Int. Cl. H04Q 7/20

(52) U.S. Cl. 455/446

(57) ABSTRACT

A weaker cell is discovered in a mobile communication system that also includes a stronger cell. Discovery involves ascertaining a slot timing of a received signal that has passed through a channel. The slot timing is used to ascertain a stronger secondary synchronization vector contained in the received signal. A channel estimate is generated, and used with the stronger secondary synchronization vector to generate a cancellation signal that is an estimate of a stronger secondary synchronization vector component of the received signal. Removing the cancellation signal from the received signal yields a residual signal. The slot timing is used to ascertain a weaker secondary synchronization vector contained in the residual signal. The weaker secondary synchronization vector is used to ascertain a group identifier (ID) of the weaker cell. The group ID of the weaker cell and the residual signal are used to ascertain the weaker cell's scrambling code ID.

### BACKGROUND

The invention relates to detection of cells in a mobile communication system, and more particularly to the detection of cells that are hidden by the signals of stronger cells transmitting in the same area.

In a Universal Mobile Terrestrial System (UMTS) cellular system, each mobile terminal, referred to as User Equipment (UE), needs to find cells before it can attempt to establish a connection with a network. This is known as the cell search process, and is composed of three stages specified by 3GPP protocols: slot synchronization, frame synchronization/code-group identification and scrambling code identification. In brief, these stages are:

1. Using a signal received on a Primary Synchronization Channel (P-SCH), detect the 5 ms timing of a new cell. This involves correlating a received P-SCH signal against known primary synchronization signals, and detecting where, in the received signal, the correlation is at its maximum.

2. Detect frame timing and Cell group using a signal received on a Secondary Synchronization Channel (S-SCH). This involves correlating a received S-SCH signal against known secondary synchronization signals, and detecting where, in the received signal, the correlation is at its maximum.

3. Use reference symbols (also called CQI pilots) transmitted on a Common Pilot Channel (CPICH) to detect the cell ID. Here, the pilot signal is scrambled with a pseudorandom noise sequence (pn-sequence) that determines the cell ID. By assuming the channel that affects the CPICH over a certain interval (one or two slots in WCDMA) is constant, one can detect the scrambling sequence, and hence the cell ID, easily.

With the synchronization scheme design in the 3GPP specification, there is an inherent issue raised by the possibility that that some cells can never be discovered by a UE in a certain area. Such cells are called “hidden cells”.

FIG. 1a is a drawing illustrating how a hidden cell can come into existence. As shown, the signals from a cell A as well as those from a cell B reach a particular geographical area 101. If the cells A and B have the same slot boundary, then whichever of the cells A and B having a stronger signal in the geographical area 101 can effectively hide the other from a UE 103 located in the geographical area 101.

The phenomenon of a hidden cell is further illustrated in FIG. 1b, which depicts graphs of signal strength of overlapping S-SCH signals plotted against time for each of the cells A and B. In this example, the signal strength for cell A's S-SCH are much stronger than those of cell B, and therefore overpower cell B's signals to the extent that a UE in the vicinity of these signals is unable to detect those belonging to cell B.

The inventors have considered one possible solution to this problem that involves using an extra path searcher together with the neighbor cell list obtained from the network. In particular, a UE would locate and consequently connect with the strongest of the cells having overlapping synchronization signals in the geographical area. The UE would then obtain a neighbor cell list from the cell to which it is connected. The cell list would provide the UE with sufficient information about neighboring cells for it to estimate which, if any, might be hidden cells, and would then use an extra path searcher to verify the suspected one or more hidden cells.

Such a solution has two primary disadvantages:
1) An extra path searcher is needed; and
2) The process is viable only after first camping on a cell.

It is therefore desirable to provide improved methods and apparatuses for finding hidden cells in a communication system.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods and apparatuses for discovering a weaker cell in a mobile communication system that includes the weaker cell and a stronger cell. Such discovery includes receiving a signal that has passed through a channel, and ascertaining a slot timing of the received signal. The slot timing is used to ascertain a stronger secondary synchronization vector contained in the received signal. Also, an estimate of the channel is generated, and used along with the stronger secondary synchronization vector to generate a cancellation signal that is an estimate of a stronger secondary synchronization vector component of the received signal. A residual signal is generated by removing the cancellation signal from the received signal. The slot timing is used to ascertain a weaker secondary synchronization vector contained in the residual signal. The weaker secondary synchronization vector is used to ascertain a group identifier (ID) of the weaker cell. The group ID of the weaker cell and the residual signal are used to ascertain a scrambling code ID of the weaker cell.

In some embodiments, removing the cancellation signal from the received signal comprises subtracting the cancellation signal from the received signal.

The estimate of the channel can be generated in any of a number of ways. In one example, channel estimate generation includes using the stronger secondary synchronization vector to generate the estimate of the channel. In alternative embodiments, channel estimate generation includes using the slot timing to ascertain a stronger secondary synchronization vector contained in the received signal. The stronger secondary synchronization signal vector is used to ascertain a group ID of the stronger cell. The group ID of the stronger cell and the received signal are used to ascertain a scrambling code ID of the stronger cell. The stronger cell is then camped on, and a channel estimate is generated based on a pilot channel of the stronger cell.

### BRIEF DESCRIPTION OF THE DRAWINGS

The objects and advantages of the invention will be understood by reading the following detailed description in conjunction with the drawings in which:

FIG. 1a is a drawing illustrating how a hidden cell can come into existence.

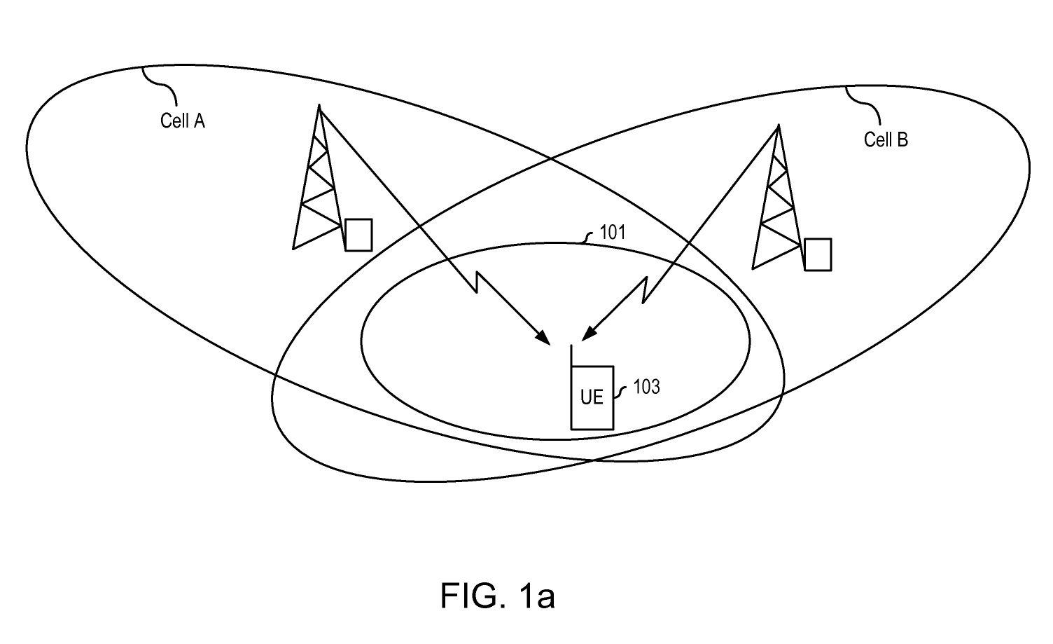

FIG. 1b depicts graphs of signal strength of overlapping S-SCH signals plotted against time for each of the cells A and B, wherein the greater strength of one cell's signals cause the other to be effectively hidden from discovery.

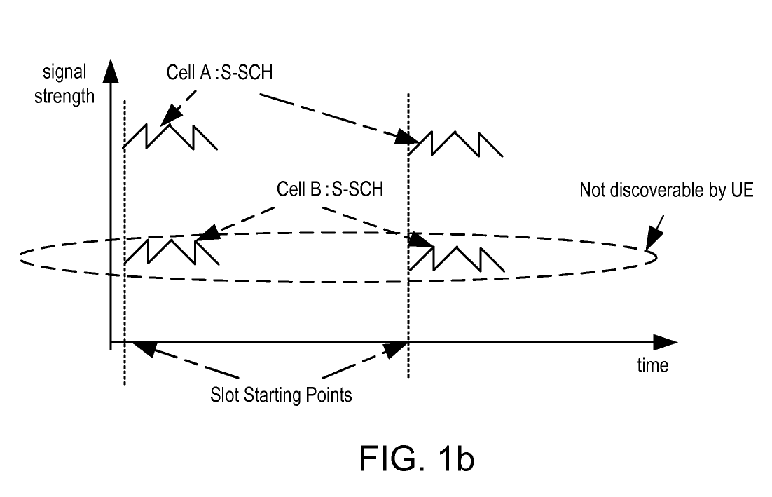

FIG. 2 can be considered to be a flowchart of steps/processes carried out in a UE in accordance with embodiments consistent with the invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

In an aspect of embodiments consistent with the invention, active cancellation is applied to received SCH signals such that SCH signals from strong cells are substantially removed, thereby rendering those from weaker cells detectable. These and other aspects will now be described in further detail in the following.

Suppose the received SCH signal vector is (P-SCH is ignored):

Rₙ=h_{A}Sₙ^{(A)}+h_{B}Sₙ^{(B)}+N

where:
n is the slot number;
N is a noise vector;
h_{A} is the radio channel from cell A;
h_{B} is the radio channel from cell B;
Sₙ^{(A)} is the S-SCH vector at slot n from cell A; and
Sₙ^{(B)} is the S-SCH vector at slot n from cell B.

Without loss of generality, assume that cell A is stronger than cell B. The conventional cell searching method will then be able to identify Sₙ^{(A)} at each slot after stage 2 processing.

The channel estimate, ĥ_{A}, of cell A can be obtained by conventional methods either from the SCH signal, or from the CPICH if the UE has already camped on the cell A.

Having obtained these parameters, a scaled version of the stronger signal from the received signal vector constitutes a cancellation signal, C, that satisfies:

C=αĥ_{A}Sₙ^{(A)}.

where a represents a confidence level on the channel estimate. It is preferably a value between 0 and 1. An exemplary technique for choosing a value for α is as follows: The stronger cell A is identified, and its CPICH Ec/N0 (which is the common pilot channel energy per chip divided by the noise density on that frequency) is determined. The value of α can then be chosen as a function of Ec/N0: the higher Ec/N0, the higher α is.

The cancellation signal, C, is then removed (e.g., by subtracting it from the received signal), thereby yielding a residual signal that satisfies:

R̅ₙ=Rₙ−αĥ_{A}Sₙ^{(A)}=Rₙ−C.

Following active cancellation, steps/processes normally associated with conventional stage 2 of the cell search procedure is performed on the residual signal. This processing allows Sₙ^{(B)} to be identified, thereby revealing the previously hidden cell.

In another aspect of embodiments consistent with the invention, the hidden cell discovery procedure is not applied in all cases. Instead, the UE first evaluates the need to initiate the hidden cell search procedure, and only performs that extra processing when needed. When that processing is not performed, what remains is conventional stage 2 processing.

In yet another aspect of embodiments consistent with the invention, reliability can be improved by obtaining and then averaging values over a suitable period of time. This would not have a significant negative effect on the time requirement in the initial stage.

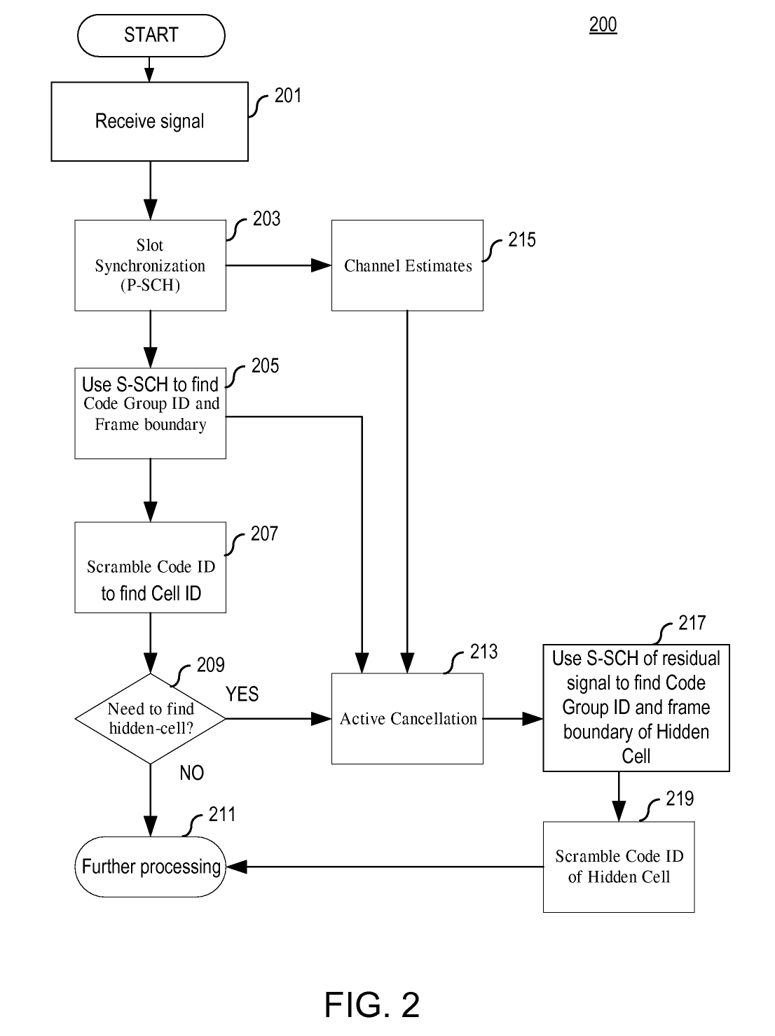

To further illustrate aspects of embodiments consistent with the invention, FIG. 2 can be considered to be a flowchart of steps/processes carried out in a UE. FIG. 2 can also be considered to depict a UE 200 having logic configured to perform the variously described functions.

The illustrated processing begins at the point at which the UE 200 needs to perform a cell search procedure. After receiving a signal (step 201) that may or may not include signal components from more than one cell, stage 1 processing is performed, whereby the P-SCH signal is analyzed by suitable logic configured to identify the slot timing (step 203). It will be observed that the presence of the hidden cell does not hinder this operation since, by definition, its signal strength is less than that of the P-SCH associated with the stronger cell. Moreover, the two cells share substantially the same slot timing.

Next, stage 2 processing is performed, whereby the UE 200 uses the S-SCH to find the Code Group ID and the frame boundary (step 205). If there is a hidden cell, the Code Group ID will correspond to the cell having the strongest S-SCH signal.

Following this, stage 3 processing is performed, whereby the UE 200 scrambles the pilot signal with a number of possible pseudorandom noise sequences (pn-sequence) to determine which one was applied at the transmitter side—this one informs the UE 200 of the cell ID (step 207).

If considered outside of the context of FIG. 2, the steps 203, 205, 207 constitute a conventional cell search procedure, and therefore need not be described in greater detail.

However, in accordance with an aspect of some embodiments of the invention, a test is performed to determine whether an attempt should be made to find a hidden cell (decision block 209). This determination can, in some embodiments, simply be a configuration in software in which an attempt is always made to try to find a hidden cell. If there is no need to search for a hidden cell (“NO” path out of decision block 209), then further processing is performed in a conventional manner (step 211). The nature of the further processing is application specific, and is beyond the scope of the invention.

However, if a hidden cell search is to be performed (“YES” path out of decision block 209), then the logic in the UE 200 performs active cancellation (step 213), for example as described above. In the exemplary embodiment, this involves generating an estimate of the channel (step 215), and using this with the S-SCH signal vector (obtained from step 205) to generate a cancellation signal that that is an estimate of the S-SCH signal vector of the strongest component of the received signal. A residual signal is then generated by removing the cancellation signal from the received signal.

The slot timing found earlier (step 203) is then applied to the residual signal to identify the S-SCH vector included in the residual signal, which in turn enables the UE 200 to ascertain the Code Group ID and the frame boundary of the hidden cell (step 217). In essence, stage 2 processing is performed on the residual signal.

Following this, stage 3 processing is performed on the residual signal, whereby the UE 200 scrambles the pilot signal with a number of possible pseudorandom noise sequences (pn-sequence) to determine which one was applied at the transmitter side—this one informs the UE 200 of the cell ID of the Hidden Cell (step 219).

Following this, further processing is performed in a conventional manner (step 211). As mentioned earlier, the nature of the further processing is application specific, and is beyond the scope of the invention.

In alternative embodiments, it may be desired to find more than one hidden cell. If this is the case, then further active cancellation could be applied to the already-generated residual signal to detect even weaker signal components of second, third, . . . , etc. hidden cells.

It will be observed that extra processing is required to detect a hidden cell. This extra processing adds delay to the cell search procedure. However, as cell search is typically performed in an initial stage of UE processing, this is not believed to be overly detrimental to the overall performance of the UE.

The various embodiments consistent with the invention enable hidden cells to be found without requiring an extra path searcher. Furthermore, the techniques can be applied even during a UE's initial processing.

The invention has been described with reference to particular embodiments. However, it will be readily apparent to those skilled in the art that it is possible to embody the invention in specific forms other than those of the embodiment described above.

For example, the various embodiments have used terminology and procedures associated with WCDMA communication systems. However, the various aspects of the invention are also applicable to other systems. For example, 3G Long Term Evolution (LTE) systems have a similar three-stage search procedure that utilizes primary- and secondary-synchronization signals as well as reference signals. The first and second stages of the LTE cell search procedure utilize the primary- and secondary-synchronization signals to, among other things, find slot and frame timing, respectively. It will be apparent to those of ordinary skill in the art that the principles involved in the above-described exemplary embodiments are easily adapted for use in an LTE system for the purpose of finding hidden cells.

Thus, the described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of discovering a weaker cell in a mobile communication system that includes the weaker cell and a stronger cell, the method comprising:
receiving a signal that has passed through a channel;
ascertaining a slot timing of the received signal;
using the slot timing to ascertain a stronger secondary synchronization vector contained in the received signal;
generating an estimate of the channel;
using the estimate of the channel and the stronger secondary synchronization vector to generate a cancellation signal that is an estimate of a stronger secondary synchronization vector component of the received signal;
generating a residual signal by removing the cancellation signal from the received signal;
using the slot timing to ascertain a weaker secondary synchronization vector contained in the residual signal;
using the weaker secondary synchronization vector to ascertain a group identifier (ID) of the weaker cell; and
using the group ID of the weaker cell and the residual signal to ascertain a scrambling code ID of the weaker cell.

2. The method of claim 1, wherein removing the cancellation signal from the received signal comprises subtracting the cancellation signal from the received signal.

3. The method of claim 1, wherein generating an estimate of the channel comprises using the stronger secondary synchronization vector to generate the estimate of the channel.

4. The method of claim 1, wherein generating an estimate of the channel comprises:
using the slot timing to ascertain a stronger secondary synchronization vector contained in the received signal;
using the stronger secondary synchronization signal vector to ascertain a group ID of the stronger cell;
using the group ID of the stronger cell and the received signal to ascertain a scrambling code ID of the stronger cell;
camping on the stronger cell; and
generating a channel estimate based on a pilot channel of the stronger cell.

5. The method of claim 1, wherein:
the received signal satisfies:
Rₙ=h_{A}Sₙ^{(A)}+h_{B}Sₙ^{(B)}+N
where:
n is the slot number;
N is a noise vector;
h_{A} is the radio channel from the stronger cell;
h_{B} is the radio channel from the weaker cell;
Sₙ^{(A)} is the S-SCH vector at slot U from the stronger cell; and
Sₙ^{(B)} is the S-SCH vector at slot n from the weaker cell;
and wherein the cancellation signal, C, satisfies:
C=αĥ_{A}Sₙ^{(A)}
where a represents a confidence level on the channel estimate.

6. The method of claim 5, wherein the residual signal, R̅ₙ, satisfies:
R̅ₙ =Rₙ−αĥ_{A}Sₙ^{(A)}.

7. An apparatus for discovering a weaker cell in a mobile communication system that includes the weaker cell and a stronger cell, the apparatus comprising:
logic configured to receive a signal that has passed through a channel;
logic configured to ascertain a slot timing of the received signal;
logic configured to use the slot timing to ascertain a stronger secondary synchronization vector contained in the received signal;
logic configured to generate an estimate of the channel;
logic configured to use the estimate of the channel and the stronger secondary synchronization vector to generate a cancellation signal that is an estimate of a stronger secondary synchronization vector component of the received signal;
logic configured to generate a residual signal by removing the cancellation signal from the received signal;
logic configured to use the slot timing to ascertain a weaker secondary synchronization vector contained in the residual signal;
logic configured to use the weaker secondary synchronization vector to ascertain a group identifier (ID) of the weaker cell; and
logic configured to use the group ID of the weaker cell and the residual signal to ascertain a scrambling code ID of the weaker cell.

8. The apparatus of claim 7 wherein the logic configured to generate the residual signal by removing the cancellation signal from the received signal comprises logic configured to generate the residual signal by subtracting the cancellation signal from the received signal.

9. The apparatus of claim 7 wherein the logic configured to generate the estimate of the channel comprises logic configured to use the stronger secondary synchronization vector to generate the estimate of the channel.

10. The apparatus of claim 7 wherein the logic configured to generate the estimate of the channel comprises:
logic configured to use the slot timing to ascertain a stronger secondary synchronization vector contained in the received signal;
logic configured to use the stronger secondary synchronization signal vector to ascertain a group ID of the stronger cell;
logic configured to use the group ID of the stronger cell and the received signal to ascertain a scrambling code ID of the stronger cell;
logic configured to camp on the stronger cell; and
logic configured to generate a channel estimate based on a pilot channel of the stronger cell.

11. The apparatus of claim 7 wherein:
the received signal satisfies:
Rₙ=h_{A}Sₙ^{(A)}+h_{B}Sₙ^{(B)+}N
where:
n is the slot number;
N is a noise vector;
h_{A} is the radio channel from the stronger cell;
h_{B} is the radio channel from the weaker cell;
Sₙ^{(A)} is the S-SCH vector at slot u from the stronger cell; and
Sₙ^{(B)} is the S-SCH vector at slot n from the weaker cell;
and wherein the cancellation signal, C, satisfies:
C=αĥ_{A}Sₙ^{(A)}
where a represents a confidence level on the channel estimate.

12. The apparatus of claim 11, wherein the residual signal, R̅ₙ, satisfies:
R̅ₙ=Rₙ−αĥ_{A}Sₙ^{(A)}.
